(19) United States
(12) Patent Application Publication
(10) Pub. No.: US 2022/0301768 A1
(43) Pub. Date: Sep. 22, 2022

(54) Method for Manufacturing A Molded Composite Inductor and Molded Composite Inductor

(71) Applicants: Shenzhen Boke New Material Co., Ltd., Nanshan District Shenzhen, Guangdong (CN); Huizhou Poco Magnetic Co., Ltd., Guangdong (CN); Huizhou Boke Industry Co., Ltd., Guangdong (CN)

(72) Inventors: Guohua Wang, Nanshan District Shenzhen, Guangdong (CN); Xiongzhi Guo, Nanshan District Shenzhen, Guangdong (CN); Zhuoquan Wu, Nanshan District Shenzhen, Guangdong (CN); Yunfan Zhang, Nanshan District Shenzhen, Guangdong (CN); Qiang Xiao, Nanshan District Shenzhen, Guangdong (CN); Bohui Wang, Nanshan District Shenzhen, Guangdong (CN); Zhihang Jiang, Nanshan District Shenzhen, Guangdong (CN); Yang Chen, Nanshan District Shenzhen, Guangdong (CN); Kai He, Nanshan District Shenzhen, Guangdong (CN); Yunkai Cao, Nanshan District Shenzhen, Guangdong (CN); Yixuan Li, Nanshan District Shenzhen, Guangdong (CN)

(73) Assignees: Shenzhen Boke New Material Co., Ltd., Nanshan District Shenzhen, Guangdong (CN); Huizhou Poco Magnetic Co., Ltd., Guangdong (CN); Huizhou Boke Industry Co., Ltd., Guangdong (CN)

(21) Appl. No.: 17/279,389

(22) PCT Filed: Aug. 14, 2020
(86) PCT No.: PCT/CN2020/109046

§ 371 Date: Mar. 24, 2021

(51) Int. Cl. H01F 41/02; H01F 27/255; H01F 1/24

(52) U.S. Cl. CPC H01F 41/0246; H01F 27/255; H01F 1/24

(57) ABSTRACT

Provided are a method for manufacturing a molded composite inductor, and a molded composite inductor. The method includes: putting a plurality of conductors apart from each other into a mold, and extending two ends of each of the plurality of conductors out of the mold; filling the mold with magnetic powder such that the magnetic powder covers the plurality of conductors, and applying pressure to the magnetic powder such that the magnetic powder forms a magnetic body and is integrated with the plurality of conductors to form an inductor module.

### TECHNICAL FIELD

The present application relates to the field of electronic element preparation, for example, to a method for manufacturing a molded composite inductor and a molded composite inductor.

### BACKGROUND

With the rapid development of semiconductor devices, the requirements on inductors evolve towards high efficiency, low inductance, miniaturization, and large currents. At present, common inductors are integral inductors and ferrite wound inductors which are single independent elements. However, the current DC-DC conversion requires increasingly high power from several hundred watts to several tens of kilowatts, and a single inductor cannot withstand such high power at all. Generally, multiple inductors are used in series or parallel or combined on a circuit board.

When the circuit board is designed, a combination of multiple inductors is used to satisfy the requirement for a high-power power supply. The multiple inductors mounted on the circuit board have a large volume and cannot fully utilize the space of the circuit board.

### SUMMARY

The present application provides a method for manufacturing a molded composite inductor. The molded composite inductor manufactured by the method for manufacturing a molded composite inductor can not only satisfy the requirement for a high-power power supply but also fully utilize the space of a circuit board, thereby facilitating a miniaturization design of the circuit board.

The present application provides a molded composite inductor manufactured by the preceding method for manufacturing a molded composite inductor. The molded composite inductor can not only satisfy the requirement for the high-power power supply but also fully utilize the space of the circuit board, thereby facilitating the miniaturization design of the circuit board.

An embodiment of the present application provides a method for manufacturing a molded composite inductor. The method includes: putting a plurality of conductors apart from each other into a mold, and extending two ends of each of the plurality of conductors out of the mold; filling the mold with magnetic powder such that the magnetic powder covers the plurality of conductors; and applying pressure to the magnetic powder such that the magnetic powder is integrated with the plurality of conductors to form an inductor module.

An embodiment of the present application provides a molded composite inductor manufactured by the preceding method for manufacturing a molded composite inductor. The molded composite inductor includes a magnetic body and a plurality of conductors. The plurality of conductors are distributed apart from each other, and each of the plurality of conductors is configured to penetrate through the magnetic body and has two ends which extend out of the magnetic body.

### BRIEF DESCRIPTION OF DRAWINGS

FIG. 1 is a flowchart of a method for manufacturing a molded composite inductor according to an embodiment of the present application.

FIG. 2 is a structural diagram of a molded composite inductor manufactured by a method for manufacturing a molded composite inductor according to an embodiment of the present application.

### REFERENCE LIST

1 conductor

2 magnetic body

### DETAILED DESCRIPTION

In the description of the present application, it is to be understood that orientations or position relations indicated by terms such as “center”, “longitudinal”, “lateral”, “length”, “width”, “thickness”, “above”, “below”, “front”, “back”, “left”, “right”, “vertical”, “horizontal”, “top”, “bottom”, “inside”, “outside”, “clockwise”, “counterclockwise”, “axial”, “radial”, and “circumferential”, are based on orientations or position relations shown in the drawings. These orientations or position relations are intended only to facilitate the description of the present application and simplify the description and not to indicate or imply that an apparatus or element referred to must have such specific orientations or must be configured or operated in such specific orientations. Thus, these orientations or position relations are not to be construed as limiting the present application.

In addition, a feature defined as a “first” feature or a “second” feature may explicitly or implicitly include one or more of such features to distinguish and describe features regardless of order or weight. In the description of the present application, unless otherwise noted, the term “a plurality of” or “multiple” means two or more.

In the description of the present application, it is to be noted that unless otherwise expressly specified and limited, the term “mounted”, “connected to each other”, or “connected” is to be construed in a broad sense as securely connected, detachably connected, or integrated; mechanically connected or electrically connected; directly connected to each other or indirectly connected to each other via an intermediary; or intraconnected between two components. For those of ordinary skill in the art, the specific meanings of the preceding terms in the present application may be understood based on specific situations.

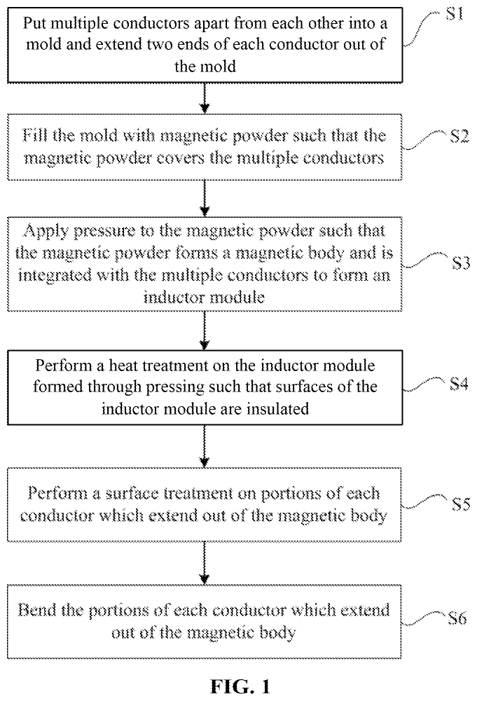

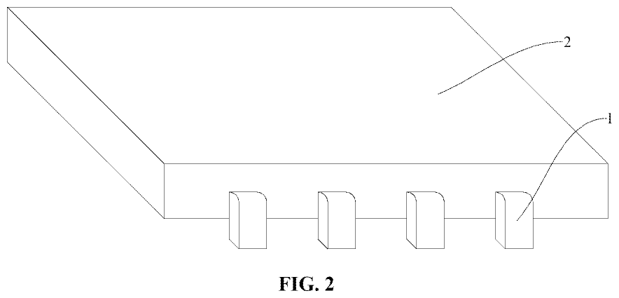

A method for manufacturing a molded composite inductor in an embodiment of the present application is described below with reference to FIG. 1 and FIG. 2.

As shown in FIG. 1, the method for manufacturing a molded composite inductor in the embodiment of the present application includes steps described below.

In S1, multiple conductors 1 are put apart from each other into a mold, and two ends of each of the multiple conductors 1 are extended out of the mold.

In S2, the mold is filled with magnetic powder such that the magnetic powder covers the multiple conductors 1.

In S3, pressure is applied to the magnetic powder such that the magnetic powder forms a magnetic body 2 and is integrated with the multiple conductors 1 to form an inductor module.

The molded composite inductor manufactured by the method for manufacturing a molded composite inductor in the embodiment of the present application can combine multiple inductive elements into the inductor module. In actual use, only one inductor module needs to be mounted on a circuit board. Compared with single independent inductive elements attached to the circuit board multiple times, the inductor module of the present application can not only improve the assembly efficiency of the circuit board but also reduce the volume of the inductor module and improve the space utilization rate of the circuit board.

Meanwhile, since the conductors 1 are put apart from each other in the mold during production, that is to say, the manufactured inductor module has multiple joints of the conductors 1 so that multiple independent inductors are formed in the inductor module. Through a circuit design, multiple inductors in the inductor module are connected in parallel or parallel, or coupled to achieve combinations with multiple electrical properties. The self-inductance and mutual inductance of multiple inductors in the inductor module may also be used to achieve multiple electrical properties. Therefore, the inductor module is more widely applied.

With the method for manufacturing a molded composite inductor in the embodiment of the present application, since the multiple conductors 1 are put apart from each other in the mold and the magnetic powder is added and pressed into shape in a manufacturing process so that the manufactured inductor module can be divided into multiple independent inductors, thereby improving the scope of application of the inductor module, reducing the volume of the inductor module, improving the space utilization rate of the circuit board, and improving the assembly efficiency of the circuit board.

In some embodiments, after S3, S4 is further included.

In S4, a heat treatment is performed on the inductor module formed through pressing such that surfaces of the inductor module are insulated.

Exemplarily, the heat treatment can not only insulate the surfaces of the inductor module and improve the use safety of the inductor module but also release thermal stress generated during the pressing, thereby ensuring the structural stability of the inductor module and preventing the magnetic powder from shedding off.

In some optional embodiments, a process of the heat treatment of the inductor module is annealing at a temperature of 450° C.

Optionally, the inductor module is annealed in the environment of air, nitrogen, or a mixture of hydrogen and nitrogen.

In the actual production process, the process of the heat treatment may be selected according to actual requirements and is not limited to the limitation in this embodiment.

In some embodiments, after S4, S5 is further included.

In S5, a surface treatment is performed on portions of each conductor 1 which extend out of the magnetic body 2.

Exemplarily, the portions of the conductor 1 which extend out of the magnetic body 2 need to be welded to the circuit board in an actual assembly process. The surface treatment performed on the portions can facilitate the assembly of the entire inductor module, thereby improving the assembly efficiency of the circuit board.

In some optional embodiments, after S5, S6 is further included.

In S6, the portions of each conductor 1 which extend out of the magnetic body 2 are bent.

Therefore, the surface attaching or insertion of the inductor module is facilitated, thereby improving the assembly efficiency of the circuit board.

In some optional embodiments, a surface treatment process includes deburring, polishing, and tinning. Therefore, the surface quality of the portions of the conductor 1 which extend out of the magnetic body 2 is ensured, thereby facilitating the welding of the conductor 1 to the circuit board.

In some optional embodiments, the magnetic powder is soft magnetic metal powder. The soft magnetic metal powder is characterized by high saturation magnetization, a low price, and good machining performance. Using the soft magnetic metal powder as the magnetic powder can reduce the manufacturing cost of the inductor module and ensure the electrical performance of the inductor module.

In some optional embodiments, the soft magnetic metal powder includes one or more of carbonyl iron powder, iron-silicon-chromium alloy powder, iron-silicon alloy powder, iron-silicon-aluminum alloy powder, iron-nickel alloy powder, or iron-nickel-molybdenum alloy powder. In other embodiments of the present application, the magnetic powder may also adopt other powder and is not limited to the above description.

In some optional embodiments, the conductor 1 is a copper piece. Therefore, the conductivity of the conductor 1 is better ensured. In other embodiments of the present application, the conductor 1 may be made of other conductive materials.

In some optional embodiments, the conductor 1 is in an elongated shape. The elongated conductor 1 facilitates the pressing of the magnetic powder and the conductor 1 into shape, thereby ensuring the reliability of the entire inductor module.

### Embodiment

A method for manufacturing a molded composite inductor in an embodiment of the present application is described below.

In a first step, four conductors 1 are put apart from each other into a mold, and two ends of each conductor 1 are extended out of the mold.

In a second step, the mold is filled with magnetic powder such that the magnetic powder covers the four conductors 1.

In a third step, pressure is applied to the magnetic powder such that the magnetic powder is integrated with the four conductors 1 to form an inductor module.

In a fourth step, annealing is performed on the inductor module formed through pressing such that surfaces of the inductor module are insulated, where the annealing is performed in air at a temperature of 450° C.

In a fifth step, deburring, polishing, and tinning are performed on portions of each conductor 1 which extend out of a magnetic body 2.

In a sixth step, the portions of each conductor 1 which extend out of the magnetic body 2 are bent.

A molded composite inductor manufactured by the method for manufacturing a molded composite inductor described above in the embodiment of the present application includes a magnetic body 2 and multiple conductors 1. The multiple conductors 1 are distributed apart from each other, and each conductor 1 penetrates through the magnetic body 2 and has two ends which extend out of the magnetic body 2.

In the molded composite inductor in the embodiment of the present application, the multiple conductors 1 are spaced apart from each other and penetrate through the magnetic body 2, thereby improving the scope of application of an inductor module, reducing the volume of the inductor module, improving the space utilization rate of a circuit board, and improving the assembly efficiency of the circuit board.

In the description of the specification, the description of reference terms such as “some embodiments” and “other embodiments” is intended to mean that specific features, structures, materials, or characteristics described in conjunction with such embodiments or examples are included in at least one embodiment or example of the present application. In the specification, the illustrative description of the preceding terms does not necessarily refer to the same embodiment or example. Moreover, the described specific features, structures, materials or characteristics may be combined in an appropriate manner in any one or more embodiments or examples.

1. A method for manufacturing a molded composite inductor, comprising:
putting a plurality of conductors apart from each other into a mold, and extending two ends of each of the plurality of conductors out of the mold;
filling the mold with magnetic powder such that the magnetic powder covers the plurality of conductors; and
applying pressure to the magnetic powder such that the magnetic powder forms a magnetic body and is integrated with the plurality of conductors to form an inductor module.

2. The method for manufacturing a molded composite inductor of claim 1, after applying the pressure to the magnetic powder such that the magnetic powder forms the magnetic body and is integrated with the plurality of conductors to form the inductor module, further comprising:
performing a heat treatment on the inductor module formed through pressing such that surfaces of the inductor module are insulated.

3. The method for manufacturing a molded composite inductor of claim 2, wherein a process of the heat treatment of the inductor module is annealing at a temperature of 450° C.

4. The method for manufacturing a molded composite inductor of claim 2, after performing the heat treatment on the inductor module formed through pressing such that the surfaces of the inductor module are insulated, further comprising:
performing a surface treatment on portions of each of the plurality of conductors which extend out of the magnetic body.

5. The method for manufacturing a molded composite inductor of claim 4, after performing the surface treatment on the portions of the each of the plurality of conductors which extend out of the magnetic body, further comprising:
bending the portions of the each of the plurality of conductors which extend out of the magnetic body.

6. The method for manufacturing a molded composite inductor of claim 4, wherein the surface treatment comprises deburring, polishing, and tinning.

7. The method for manufacturing a molded composite inductor of claim 1, wherein the magnetic powder is soft magnetic metal powder.

8. The method for manufacturing a molded composite inductor of claim 7, wherein the soft magnetic metal powder comprises at least one of carbonyl iron powder, iron-silicon-chromium alloy powder, iron-silicon alloy powder, iron-silicon-aluminum alloy powder, iron-nickel alloy powder, or iron-nickel-molybdenum alloy powder.

9. The method for manufacturing a molded composite inductor of claim 1, wherein each of the plurality of conductors is a copper piece in an elongated shape.

10. A molded composite inductor manufactured by the method for manufacturing a molded composite inductor of claim 1, comprising:
a magnetic body; and
a plurality of conductors spaced apart from each other, wherein each of the plurality of conductors is configured to penetrate through the magnetic body and has two ends which extend out of the magnetic body.

11. The molded composite inductor of claim 10, after applying the pressure to the magnetic powder such that the magnetic powder forms the magnetic body and is integrated with the plurality of conductors to form the inductor module, the method for manufacturing a molded composite inductor further comprises:
performing a heat treatment on the inductor module formed through pressing such that surfaces of the inductor module are insulated.

12. The molded composite inductor of claim 11, wherein a process of the heat treatment of the inductor module is annealing at a temperature of 450° C.

13. The molded composite inductor of claim 11, after performing the heat treatment on the inductor module formed through pressing such that the surfaces of the inductor module are insulated, the method for manufacturing a molded composite inductor further comprises:
performing a surface treatment on portions of each of the plurality of conductors which extend out of the magnetic body.

14. The molded composite inductor of claim 13, after performing the surface treatment on the portions of the each of the plurality of conductors which extend out of the magnetic body, the method for manufacturing a molded composite inductor further comprises:
bending the portions of the each of the plurality of conductors which extend out of the magnetic body.

15. The molded composite inductor of claim 13, wherein the surface treatment comprises deburring, polishing, and tinning.

16. The molded composite inductor of claim 10, wherein the magnetic powder is soft magnetic metal powder.

17. The molded composite inductor of claim 16, wherein the soft magnetic metal powder comprises at least one of carbonyl iron powder, iron-silicon-chromium alloy powder, iron-silicon alloy powder, iron-silicon-aluminum alloy powder, iron-nickel alloy powder, or iron-nickel-molybdenum alloy powder.

18. The molded composite inductor of claim 10, wherein each of the plurality of conductors is a copper piece in an elongated shape.
